(19) United States
(12) Patent Application Publication
(10) Pub. No.: US 2005/0006506 A1
(43) Pub. Date: Jan. 13, 2005

(54) Laboratory appliance having a sliding-foot supporting arrangement

(75) Inventors: Kenneth McCartney, Haan (DE); Hans-Jurgen Meyer, Ratingen (DE)

Correspondence Address: ROBERT W. BECKER & ASSOCIATES, Suite B, 707 Highway 66 East, Tijeras, NM, 87059, US

(73) Assignee: Retsch GmbH & Co. KG, Haan (DE)

(21) Appl. No.: 10/888,477

(22) Filed: Jul. 9, 2004

(30) Foreign Application Priority Data
Jul. 11, 2003 (DE) 203 10 654.7

(51) Int. Cl. B02C 17/08

(52) U.S. Cl. 241/175

(57) ABSTRACT

A laboratory appliance having a working apparatus that is driven by a drive and that during operation produces an imbalance is provided. The appliance includes at least one sliding device that permits movements only in a horizontal plane that extends parallel to the surface on which the laboratory appliance stands. The sliding device is disposed between the drive of the working apparatus, and the surface on which the laboratory appliance stands.

### BACKGROUND OF THE INVENTION

The invention relates to a laboratory appliance having a working apparatus which is driven by a drive and which, when it is in operation, produces an imbalance.

Laboratory appliances of this kind may be used, in particular, in the preparation of specimens on a laboratory scale, in which connection mention should be made, as an example of these appliances, of a planetary grinder such as is described in DE 197 12 905 A1. The problems that occur in laboratory appliances of this kind, and the invention that is to be employed in order to solve such problems, are represented with the aid of the exemplified embodiment of a planetary grinder.

A planetary grinder of this kind has a structure having a carrier apparatus, which is supported so as to be rotatable about a central axis, and having a grinding-bowl receptacle, which is disposed so as to be rotatable, in relation to the carrier apparatus, about a planetary axis and is entrained by the carrier apparatus, for at least one grinding bowl which is inserted in the grinding-bowl receptacle and contains grinding bodies, wherein the carrier apparatus and the grinding-bowl receptacle are driven by means of at least one drive and an adjustable mass-counterbalancing device is associated with the carrier apparatus.

In a planetary grinder of this kind, which is described in DE 197 12 905 A1, a mass-counterbalancing device is already provided, for the purpose of achieving smooth rotation, with a counterweight which can be adjusted on a rail in order to be able to compensate for the different inertial forces associated, for example, with the use of grinding bowls of different sizes. This document also contains a reference to the fact that it should also be possible to adapt the vertical location of the center of gravity of the mass of the mass-counterbalancing device, according to the variation in the vertical location of the center of gravity of the mass in grinding bowls of different size. With this measure, adequate mass-counterbalancing is basically possible in the middle rotational-speed ranges of known planetary grinders.

However, in the case of planetary grinders with grinding bodies contained therein, rotating movements of the grinding bowls which are oppositely directed in relation to the carrier apparatus which is likewise rotating, result in the grinding bodies in the grinding bowl being initially entrained, as a result of the centrifugal forces acting upon them, in the direction of rotation of the grinding bowl by the wall of said grinding bowl; under these circumstances, differences in speed between the grinding bodies and the wall of the grinding bowl occur, so that correspondingly strong friction is exerted on the particles of material to be ground which are lying between them. Because of the Coriolis forces acting upon the grinding bodies as the rotating movement progresses further, the grinding bodies become detached from the wall of the grinding bowl. The grinding bodies move through the grinding bowl and impinge, in the region of the opposite wall of the grinding bowl, with considerable impact energy upon the material to be ground. There therefore occur, particularly in the case of large grinding bowls and/or grinding bodies of large diameter, continuously changing irregularities in the distribution of the mass of the grinding bodies in the grinding bowl, which irregularities can no longer be controlled with the known mass-counterbalancing device, particularly at the high speeds of rotation, which are customary these days, of modern high-performance grinders.

These irregularities which occur have an adverse effect, particularly in the case of planetary grinders which are designed in the form of a bench model. Benches form, with their vertically attached legs and the planetary grinder which has been deposited on their bench-top, a spring-and-mass system which is induced, as a result of the free inertial forces that occur, to perform considerable vibrations at its inherent frequency in dependence upon the rotational speed of the grinder. The vibrations of the laboratory bench that thus occur may lead to the functioning of adjacent laboratory appliances on the benches being impaired, or to the entire planetary grinder moving across the bench spontaneously, depending upon the nature of the surface of the bench-top. These possible movements of the grinders carry considerable safety risks, particularly if account is taken of the fact that grinders of this kind with preselectable starting times are supposed to be capable of starting up automatically without supervision.

The underlying object of the invention is therefore to counterbalance mass vibrations that occur in a laboratory appliance having the aforementioned general features, and to establish a steady state for the laboratory appliance.

### SUMMARY OF THE INVENTION

In its basic concept, the invention makes provision for at least one sliding device, which permits only movements in the horizontal plane extending parallel to the surface on which the laboratory appliance stands, to be interposed between the drive and the standing surface.

The concept of the invention therefore aims at permitting exclusively horizontal movements when the laboratory appliance is set up, because the disposition of, for example, elements which are also resilient in the vertical direction would lead to the production of new spring-and-mass systems which do not eliminate, but may even intensify, the disadvantage described. Since, according to the invention, the laboratory appliance is freely movable in the horizontal plane because of the interposed sliding device or devices, circular vibrations of the laboratory appliance occur, the radius of which is proportional, for example in the planetary grinder mentioned as an exemplified embodiment, to the active radius of the imbalance mass, multiplied by the ratio of the imbalance mass to the mass of the machine. Since the mass of the machine is much greater than the imbalance mass can become, even if the counterbalancing mass has been inaccurately set, only minor vibrational movements of the planetary grinder occur, the forces transmitted to the bench by the grinder in the process being almost equal to zero, or of the order of magnitude of the frictional forces that arise.

According to one exemplified embodiment of the invention, provision is made for the drive to be fastened on a plate disposed in a movable manner inside the housing of the laboratory appliance and for the at least one sliding device to be disposed between the plate and a load-bearing part of the housing; in this case, therefore, the forces caused by the imbalance mass are already absorbed inside the housing of the laboratory appliance.

Alternatively, provision may be made for a sliding device to be integrated into each of the standing feet of the housing; in this case, the standing feet of the housing are each equipped for absorbing the imbalance forces.

Under these circumstances, provision may be made for the sliding device to comprise a sliding plate which is disposed in a horizontally movable manner in a housing of the standing foot and is mounted on the housing. Accordingly, the sliding plate may therefore either be the plate that carries the drive, or else suitable sliding plates may be constructed as carriers for the base of the housing as part of the standing feet of the housing.

If the sliding device is constructed in a standing foot, provision may be made, for the purpose of mounting the sliding plate on the housing, for a holding element, which comprises an elastic material, to be disposed between the sliding plate and the housing and to be fixedly connected to the housing and the sliding plate in each case. In this case, provision may be made for the holding element to secure the sliding plate in position on the housing with pretensioning, so that the individual parts of the standing foot are held together with the sliding device.

According to one exemplified embodiment of the invention, provision is made for the holding element to be constructed in the shape of a bar with the possibility of lateral deflection.

For the purpose of constructing the sliding device, provision is made, according to one exemplified embodiment of the invention, for the housing to be constructed in the shape of a pot with a central recess for receiving the holding element, the side walls of the housing being provided, in their upper region that faces towards the sliding plate, with a receptacle for sliding elements that support the sliding plate.

Under these circumstances, provision may be made, in a first form of embodiment, for the sliding elements to comprise bearing balls disposed in the receptacle, so that the sliding plate is supported on the housing via balls.

Alternatively, provision may be made for the sliding elements comprise a sliding disc which is disposed in the receptacle in the housing and is constructed in the shape of a ring, in which case the sliding disc may, according to one exemplified embodiment, comprise Teflon.

According to one exemplified embodiment of the invention, provision is made for the sliding plate to be provided, on its underside that faces towards the housing, with a projection which protrudes into the recess and encompasses the holding element, and for a stop ring to be disposed on the outer periphery of the projection for the purpose of limiting the horizontal sliding movement of the sliding plate in relation to the housing.

According to one exemplified embodiment, the invention can be applied, in a particularly suitable manner, to a planetary grinder, the latter being driven by means of at least one drive and an adjustable mass-counterbalancing device being associated with the carrier apparatus.

Equally, however, provision may be made for the laboratory appliance equipped in accordance with the invention to be constructed as a disc-type vibration grinder or as a centrifuge; however the application of the concept of the invention is not confined to the aforementioned laboratory appliances; on the contrary, other laboratory appliances may also be equipped using the concept of the invention.

### BRIEF DESCRIPTION OF THE DRAWINGS

Exemplified embodiments of the invention which are described below are reproduced, applied to a planetary grinder as the laboratory appliance, in the drawings, in which:

FIG. 1 shows a planetary grinder in a partially cut-away side view;

FIG. 2 shows, in a cut-away side view, a standing foot of the housing, which standing foot is provided with a sliding device; and

FIG. 3 shows the subject-matter of FIG. 2 in another form of embodiment.

### DESCRIPTION OF SPECIFIC EMBODIMENTS

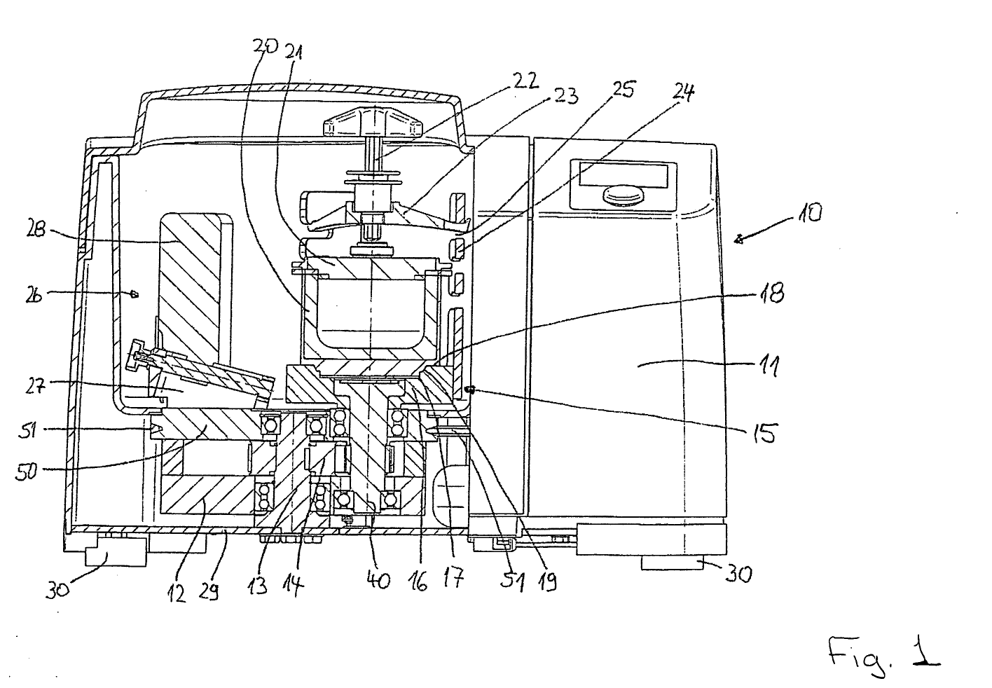

A housing 10 of a planetary grinder has an operating or control part 11; in the region adjoining the operating part 11, there is disposed a carrier apparatus 12 which surrounds a central axis 13. The carrier apparatus 12 is to be set in rotation by means of a driving pulley 50 which is likewise rotatably supported at the central axis 13, the driving pulley 50 being capable of being driven, via a V-belt 51 acting on its periphery, by means of a driving motor which is fastened on a base plate 29 of the housing but is not visible in the representation in FIG. 1.

Disposed on the carrier apparatus 12, eccentrically in relation to the central axis 13, is a grinding-bowl receptacle 15 which is rotatable about a planetary axis 40 by means of an associated transmission 14 in a manner driven by the driving pulley 50, and which has a specially shaped base region 16 for receiving a grinding bowl 20; the base region has an inner region 17 of the diameter which has a smaller diameter and an outer region 18 of the diameter which has a larger diameter, a conical supporting surface 19 being disposed between the two regions 17, 18 of the diameter.

In the exemplified embodiment represented, the grinding bowl 20 has a base which is adapted to the configuration of the base region 16 of the grinding-bowl receptacle 15, so that the grinding bowl 20 is inserted and received in the grinding-bowl receptacle 15 in a form-locking manner.

The clamping structure for securing the grinding bowl 20 in position comprises a securing spindle 22 which extends through a bracket 23 and presses on the lid 21 of the grinding bowl 20. The bracket 23 engages, with lateral arms, in clearances 25 in the grinding-bowl mounting arrangement 24, which thus forms the abutment for the clamping device. The grinding bowl 20 is clamped into the grinding-bowl receptacle 15 by the tightening of the securing spindle 22.

On the opposite side with respect to the central axis 13, there is disposed a mass-counterbalancing device 26 which comprises a counterweight 28 which is displaceably guided on a guide body 27. The guide body 27 is disposed, in the form of a rail that guides the counterweight 28, in a manner ascending outwards from the central axis at an angle to the plane of rotation of the carrier apparatus 12, in such a way that the distance of the center of gravity of the counterweight 28 from the plane of rotation of the carrier apparatus 12 changes when the counterweight 28 is displaced.

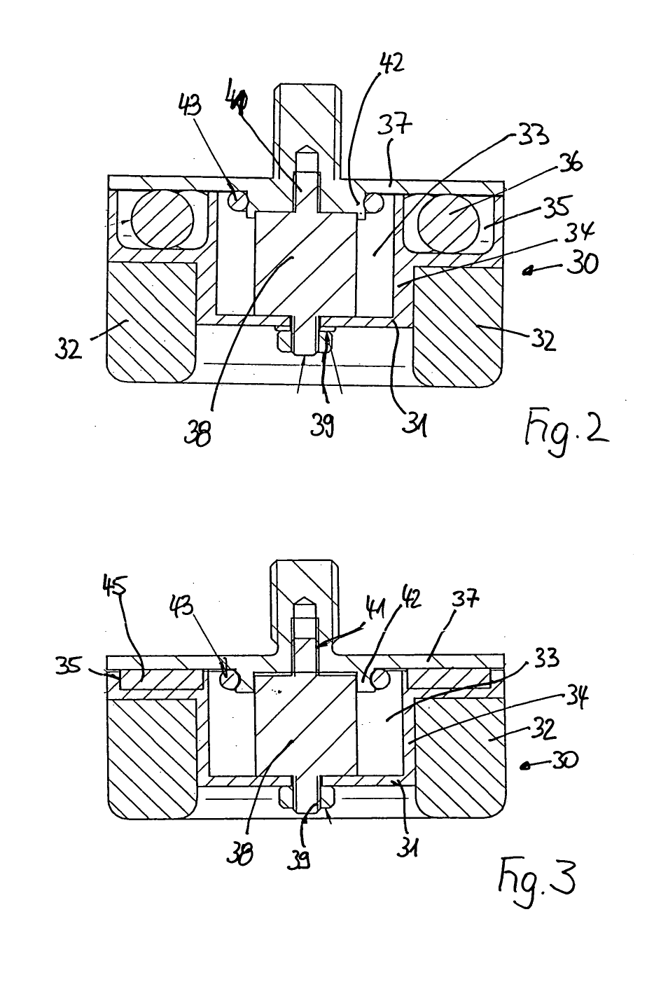

As emerges from FIGS. 2 and 3, a suitable sliding device is integrated, in each case, into the base or standing foot, which is designated by 30 in FIG. 1, of the housing 10 of the planetary grinder. To that end, the standing foot 30 comprises a housing 31 which is supported on a supporting part 32 which rests on the surface on which the housing 10 stands. The housing 31 is provided, in a pot-shaped manner, with a central recess 33 and, in the upper region of the side walls 34 of the housing 31, the side walls 34 form a U-shaped receptacle 35 for receiving suitable sliding elements which comprise, in the example represented in FIG. 2, sliding balls 36. Supported on the sliding balls 36 is a sliding plate 37 which, in a manner corresponding to FIG. 1, is connected, in each case, to the base plate 29 of the housing 10 in a suitable manner; naturally, the base plate 29 of the housing 10 rests on a number of such sliding plates 37 in the form of components of a number of standing feet 30.

For the purpose of mounting the sliding plate 37 on the housing 31, a holding element 38 comprising an elastic material, for example a rubber, is disposed in the recess 33 between the sliding plate 37 and the housing 31 and is fixedly connected, in each case, to the base of the housing 31 via a clamping-in arrangement 39 and to the sliding plate 37 via a clamping-in arrangement 41. Because of the fixed connection of the holding element 38 to the housing 31 and the sliding plate 37, it is possible to secure the parts in position against one another with a certain pretensioning, in order to guarantee friction-less functioning. The holding element 38 is therefore constructed from a resiliently elastic material in order to apply a certain restoring force into the central position in the event of lateral deflection of the sliding plate 37 in relation to the housing 31; if spring-and-mass forces occur in the process, these may be disregarded.

With a projection 42 constructed on its underside, the sliding plate 37 encloses the holding element 38 and thereby ensures additional stability; a stop ring 43, for example made of Teflon, is provided on the outer periphery of the projection 42 in order to limit the lateral movements of the sliding plate 37 in relation to the housing 31. All in all, experience has shown that a lateral displacement path of about 1 to 3 mm is sufficient in the case of currently customary grinder configurations.

The exemplified embodiment represented in FIG. 3 differs from that previously described in connection with FIG. 2 essentially through the fact that, as opposed to the ball-type supporting arrangement represented in FIG. 2, a sliding disc 45, which comprises Teflon and on which the sliding plate 37 is supported, is inserted in the receptacle 35.

Those features of the subject matter of these documents which are disclosed in the above description, the claims and the drawings may be essential, individually and also in any desired combinations with one another, to the realization of the invention in its various forms of embodiment.

The specification incorporates by reference the disclosure of German priority document 203 10 654.7 filed Jul. 11, 2003

The present invention is, of course, in no way restricted to the specific disclosure of the specification and drawings, but also encompasses any modifications within the scope of the appended claims.

1. A laboratory appliance having a working apparatus that is driven by a drive and that during operation produces an imbalance, comprising:
at least one sliding device that permits movements only in a horizontal plane that extends parallel to a surface on which said laboratory appliance stands, wherein said at least one sliding device is disposed between said drive of said working apparatus, and said surface on which said laboratory appliance stands.

2. A laboratory appliance according to claim 1, which further comprises a housing, wherein said drive of said working apparatus is secured on a plate that is moveably disposed within said housing, and wherein said at least one sliding device is disposed between said plate and a load-bearing part of said housing.

3. A laboratory appliance according to claim 1, which further includes a housing that, via individual standing feet, stands on said surface on which said laboratory appliance stands, wherein a respective sliding device is integrated into each of said standing feet.

4. A laboratory appliance according to claim 3, wherein each of said standing feet is provided with a housing, and wherein each of said sliding devices comprises a sliding plate that is disposed in said housing of said standing foot in a horizontally moveable manner and is mounted on said housing.

5. A laboratory appliance according to claim 4, wherein, for said mounting of said sliding plate on said housing, a holding element of an elastic material is disposed between said sliding plate and said housing and is fixedly connected to said housing and said sliding plate.

6. A laboratory appliance according to claim 5, wherein said holding element secures said sliding plate in position on said housing with pretensioning.

7. A laboratory appliance according to claim 5, wherein said holding element has a bar-shaped configuration with a possibility of lateral deflection.

8. A laboratory appliance according to claim 5, wherein said housing of said standing foot has a pot-shaped configuration with a central recess for receiving said holding element, and wherein side walls of said housing, in an upper region that faces said sliding plate, are provided with a receptacle for sliding elements that support said sliding plate.

9. A laboratory appliance according to claim 8, wherein said sliding elements comprise bearing balls that are disposed in said receptacle such that said sliding plate is supported on said housing via said balls.

10. A laboratory appliance according to claim 8, wherein said sliding elements comprise a ring-shaped sliding disc that is disposed in said receptacle of said housing.

11. A laboratory appliance according to claim 10, wherein said sliding disc is comprised of Teflon.

12. A laboratory appliance according to claim 1, which is in the form of a planetary grinder having a carrier apparatus that is supported so as to be rotatable about a central axis, and further having a grinding-bowl receptacle that is disposed so as to be rotatable, relative to said carrier apparatus, about a planetary axis, is entrained by said carrier apparatus, and is provided for at least one grinding bowl that is disposed in said receptacle and contains grinding bodies, wherein said carrier apparatus and said receptacle are driven by means of at least one drive, and wherein an adjustable mass-counterbalancing device is associated with said carrier apparatus.

13. A laboratory appliance according to claim 1, which is in the form of a disc-type vibration grinder.

14. A laboratory appliance according to claim 1, which is in the form of a centrifuge.
